(19) United States
(12) Patent Application Publication
(10) Pub. No.: US 2010/0240877 A1
(43) Pub. Date: Sep. 23, 2010

(54) Integrated system for producing value-added products from lignin produced in the manufacturing of cellulosic ethanol

(76) Inventor: Richard Truslowe, Bloomsburg, PA (US)

Correspondence Address: Richard Truslowe, Suite 304, 240 Market Street, Bloomsburg, PA, 17815, US

(21) Appl. No.: 12/383,242

(22) Filed: Mar. 20, 2009

(51) Int. Cl. C07G 1/00; B01J 19/00

(52) U.S. Cl. 530/500; 422/129

(57) ABSTRACT

A more efficient and economical production/processing/utilization system for managing waste lignin produced in the manufacturing of cellulosic ethanol. The process is also more environmentally sound as the multiple uses of a single feedstock on and off site result in a direct reduction of life cycle green house gas emissions. The resulting benefits of this type of co-location will also speed the commercialization for cellulosic bio fuel and help reduce our dependence on foreign oil.

### FIELD OF INVENTION

This invention relates to a system for modifying waste lignin created as a by-product during the manufacturing of cellulosic bio fuel. The primary product of a cellulose based bio fuel manufacturing facility is ethanol. Certain cellulosic fuel manufacturing processes generate large amounts of waste lignin. By modifying the lignin and co-locating the bio fuel plant with a coal power plant, equipped with flue gas scrubber, and a gypsum products producer, there are unique opportunities to modify waste stream lignin for use on site. This specific type of cross product development and sharing is novel and offers unique opportunities for the co-located businesses. This invention elevates lignin from a waste or lower value by-product to a valuable co-product.

### BACKGROUND OF INVENTION

Developing higher value lignin products at cellulosic ethanol processing facilities is now viewed as critically important to making this new industry economically viable. Utilizing waste lignin directly at another, co-located manufacturing facility also serves to reduce total energy consumption, fossil fuel consumption, and greenhouse gas emissions. This invention relates to developing a high value chain of lignin products that will advance the commercialization of cellulose bio fuel manufacturing.

Many commercially available modified lignin-based materials currently exist. Waste stream lignins are modified in many ways and have a wide range of physical properties. One common example is modified lignin sulfonate. Manufacturing sulfonated lignin is a long established process. Lignins are also modified to create a range of lignin materials for use in gypsum products, cement products, pellet binders, and a wide of other uses. Lignin can also be modified to create activated carbon. This material can be produced by different processes and using different lignin or other carbon based materials.

In recent years, environmental regulations governing coal fired power plants required plants to install flue gas scrubbers. Some of these facilities installed large scale flue gas scrubbers utilizing lime to effectively remove sulfur dioxide, mercury, and other pollutants from plant emissions. At a large power plant, the scrubbing process converts many tons of lime to many tons of gypsum. Gypsum product producers have co-located large scale plants to utilize the flue gas gypsum to create products like sheetrock and other gypsum products. Many of these gypsum producers utilize modified lignin as a binder in their manufacturing processes.

Certain flue gas scrubber systems utilize activated carbon materials for the purpose of capturing mercury and other pollutants. The activated carbon serves to trap these pollutants and is regularly cycled into the system and continually replaced while the scrubber is in operation. Activated carbon materials can be produced using a range of carbon based materials including lignin.

Coal fired power plants can be modified to accept waste lignin suitable for co-firing. This requires a series of mechanical steps to prepare waste lignin in a form suitable for co-firing. This fuel change may require a range of modifications to power plant equipment.

### BRIEF SUMMARY OF THE INVENTION

There are currently no operational commercial scale (more than 2 million gallons per year) cellulosic ethanol manufacturers in operation in the United States. Production of modified lignin within a cellulosic bio fuel maker does not currently exist. Constructing this capability within a bio fuel plant has not been done and is novel. This invention allows for the construction or addition of equipment and manufacturing technology to create specific value added products from lignin from as part of a cellulosic ethanol manufacturing facility. Lignin would be collected, modified according to use, separated and delivered “over the fence” to each co-located business as follows:
1. Modified lignin for binder delivered to the gypsum products producer for direct use in production.
2. Modified lignin to make activated carbon for direct use in the flue gas scrubber system.
3. Modified lignin for direct use in at the power plant co-fired with coal.
   Modifying cellulosic lignin waste from a bio fuel plant, creating new products, creating direct physical linkages between unrelated co-located facilities described above has not been done, is novel, and presents unique opportunities for process and product development.

### BRIEF DESCRIPTION OF THE DRAWINGS

FIG. 1, provides a flowchart of the advanced biofuel products and specific value-added product connection between a co-located gypsum products manufacturer and a coal fired power plant.

FIG. 2, provides a flowchart of waste lignin as a cellulosic ethanol by-product and high-value modified lignin to be produced within a biofuel facility. The figure illustrates examples of modified lignin for direct use as binder at a gypsum manufacturing plant, modified lignin for direct use in a flue gas scrubber, and either modified or unmodified lignin for direct co-firing with coal at the coal power plant.

FIG. 3 provides a schematic diagram illustrating waste lignin generated at an advanced biofuel facility. This figure illustrates product material processing and physical plant components to be developed and integrated within the biofuel facility. This added manufacturing component would be constructed to gather, cleanse, and prepare waste lignin for modification for use as described in FIGS. 1 and 2 above. Lignin would be “batch processed” as shown to create activated carbon, lignin binders, or co-fired in a coal boiler either in modified or un-modified form. Storage containment would be built for each product as shown. Conveyance systems for each type of material would be constructed between the facilities as shown. The appropriate material for each separate use would be manufactured within the biofuel facility and conveyed to the co-located facilities.

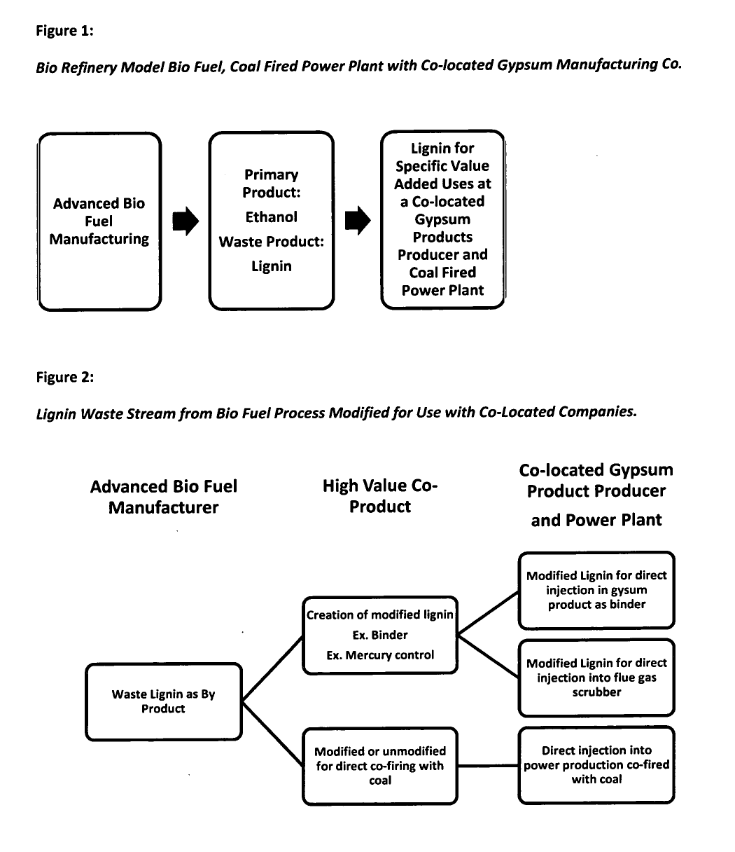

What is claimed:

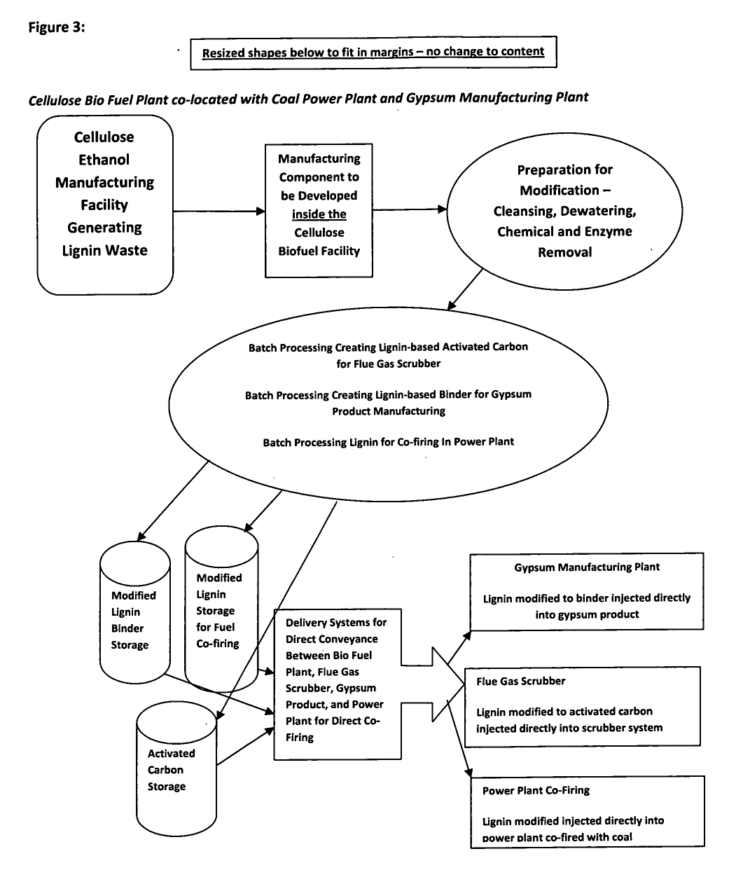

1. An integrated plant manufacturing system within a cellulosic bio fuel manufacturing operation for the processing waste lignin to produce value-added products for direct use at co-located, coal fired power plants and co-located gypsum manufacturing facilities. Product production systems with direct mechanical conveyance systems between the facilities further detailed in FIG. 3.

2. A system to produce modified lignin materials within a cellulose ethanol manufacturing facility for use at:
a. A co-located coal power plant with flue gas scrubber
b. A co-located flue gas gypsum facility manufacturing gypsum products
c. A co-located cellulosic ethanol manufacturing facility

3. Internal manufacturing processing within a biofuel manufacturing facility to produce modified lignin materials related to claim 2 above including, activated carbon, lignin sulfonates, or other types of lignin-based products, within the cellulose bio fuel plant from waste stream lignin with uses as follows:
a. A material modified for direct use as fuel co-fired with coal
b. A material modified for use as a binding agent at a co-located gypsum facility
c. A material modified for use as a dispersing agent
d. A material modified for use as stabilizing agent
e. A material modified for use as a retarding agent
f. A material modified for use as a mercury removal agent—utilized within a co-located power plant's flue gas scrubbing operation
g. Other common or uncommon legal uses for modified lignin on or outside of the site.

4. Lignin modification facility created within a cellulosic bio fuel plant for product manufacturing as outlined in claims 2 and 3 with systems to convey and deliver those modified materials as outlined in claim 1 above.
